(19) United States
(12) Patent Application Publication
(10) Pub. No.: US 2002/0091343 A1
(43) Pub. Date: Jul. 11, 2002

(54) Massage device for feet of users

(76) Inventor: Sherry Chen, Taichung (TW)

Correspondence Address: Sherry CHEN, P. O. Box 63-99, Taichung, 406, TW

(21) Appl. No.: 09/759,724

(22) Filed: Jan. 9, 2001

(51) Int. Cl. A61H 7/00

(52) U.S. Cl. 601/136

(57) ABSTRACT

A massage device for massaging feet of user includes a base having a number of massage projections extended upward from the upper surface for engaging with and for massaging the feet of the user. A handle is supported above the base for supporting the upper portion of the user. The upper surface of the base is preferably upwardly curved for increasing the massaging effect of the massage projections. One or more supports may be used for supporting the handle above the base and each includes rod adjustably secured in a tube. The handle and the supports may be received in the base.

### BACKGROUND OF THE INVENTION

1. Field of the Invention

The present invention relates to a massage device, and more particularly to a massage device for massaging the feet of the users.

2. Description of the Prior Art

Typical massage devices for feet of the users comprise a square or rectangular base having a size for supporting the feet of the user only, and having a number of motorized projections slidably and movably received in the base for being moved upward and downward relative to the base and for massaging the feet of the users. The base has the size just enough to support the feet of the user, and is not allowed for the users to conduct such as the stepping exercises on the base. In addition, the base includes a flat upper surface such that the projections may not be effectively used to massage the feet of the users.

The present invention has arisen to mitigate and/or obviate the afore-described disadvantages of the conventional massage devices for feet of the users.

### SUMMARY OF THE INVENTION

The primary objective of the present invention is to provide a massage device for massaging the feet of the users including an upwardly curved upper surface having a number of massage projections extended upward therefrom for massaging purposes.

The other objective of the present invention is to provide a massage device for massaging the feet of the users including a handle provided above the base for supporting the upper portion of the users.

In accordance with one aspect of the invention, there is provided a massage device for massaging feet of user, the massage device comprising a base including an upper surface having a plurality of massage projections extended upward therefrom for engaging with and for massaging the feet of the user, and a handle supported above the base for supporting an upper portion of the user.

The upper surface of the base is preferably upwardly curved from the base and having the massage projections extended upward therefrom. The base preferably includes a circular cross section for allowing the users to step on the base.

A supporting device is further provided for supporting the handle above the base and includes at least one tube secured on the base, a rod slidably engaged in the tube, and means for adjustably securing the rod to the tube.

The base includes at least one recess formed therein for receiving the at least one tube and the rod. The base includes at least one recess formed therein for receiving the handle.

The handle includes a depression formed therein, the massage device further includes a timing device received in the depression of the handle.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a massage device in accordance with the present invention;

FIG. 2 is a side view of the massage device;

FIG. 3 is a partial exploded view of a support or an adjustable support for the massage device; and

FIG. 4 is a bottom perspective view illustrating the folding or storing configuration of the massage device.

### DETAILED DESCRIPTION OF THE PREFERRED EMBODIMENT

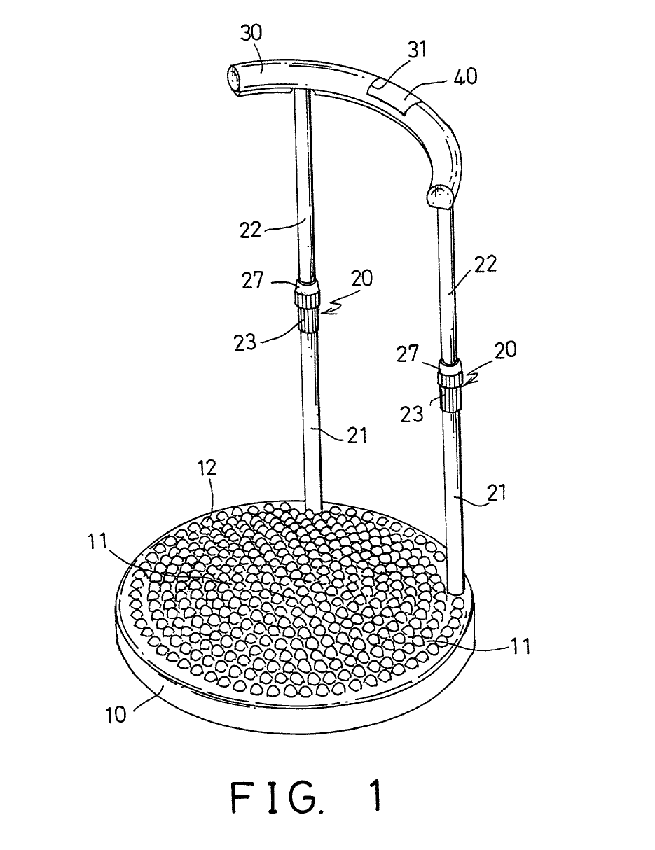

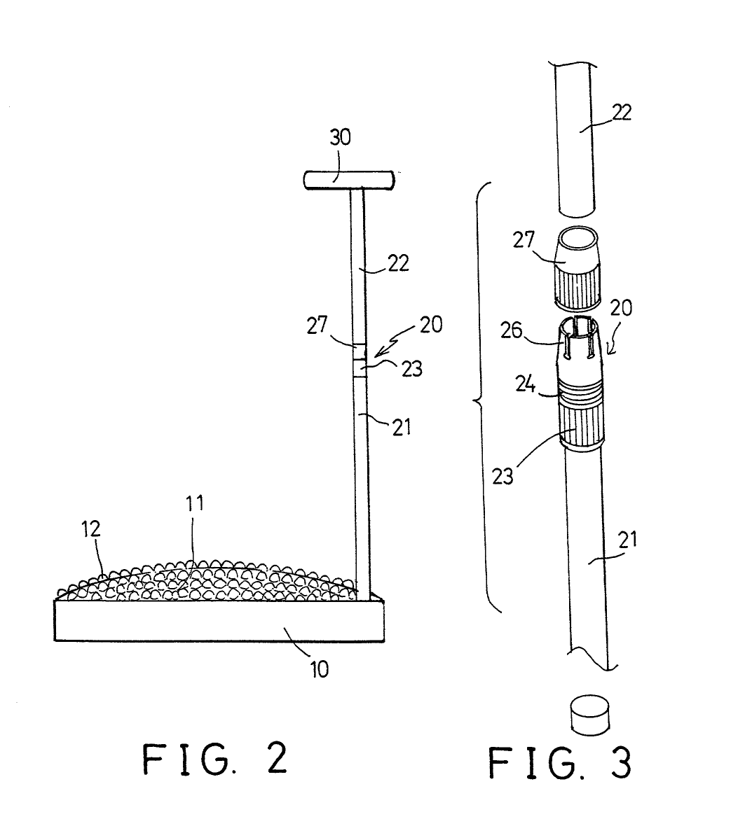

Referring to the drawings, and initially to FIGS. 1-3, a massage device in accordance with the present invention comprises a base 10 including an upwardly curved bulge 11 extended or provided on top of the base 10 and including a number of rounded projections 12 extended upward from the upwardly curved bulge 11 for engaging with and for massaging the feet of the users. The base 10 includes a bottom portion having a cavity 14 and one or more recesses 16, 17 formed therein.

A handle 30 disposed above the base 10 with one or more supports 20 for supporting the upper portion of the user. The supports 20 each includes a tube 21 secured on the base 10 with such as a force-fitted engagement or with an adhesive materials, or with fasteners etc., and includes a rod 22 slidably received in the tube 21. A barrel 23 is secured on top of the tube 21 and includes an outer thread 24 formed thereon and includes one or more spring blades 26 provided on top thereof for engaging with the rod 22. A control ferrule 27 is slidably and rotatably engaged on the rod 22 and threaded with the outer thread 24 of the barrel 23 for engaging with the spring blades 26 and for forcing the spring blades 26 to engage with the rod 22 and to secure the rod 22 to the tube 21.

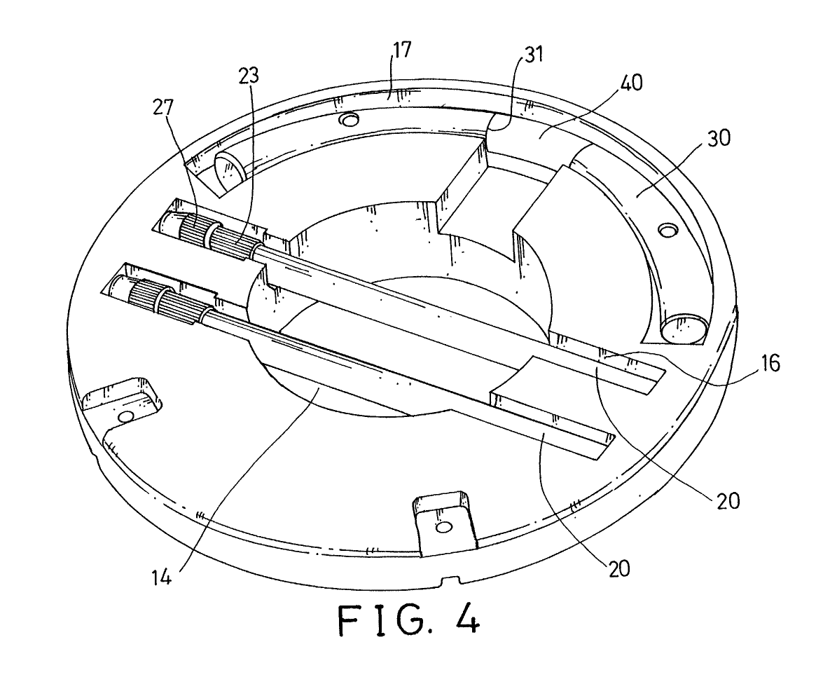

The handle 30 is secured on top of the support 20 with fasteners or the like, and includes a depression 31 formed therein for receiving a timer, an electric facility 40 or the like therein, which may be used for recording or playing a phrase or a word or a sentence or the like, and/or which may tell the time or the weight etc., for the users. The supports 20 and the handle 30 may be detached or disengaged from the base 10 and may then be received and stored in the recesses 16, 17 of the base 10 (FIG. 4) in the folded or storing position such that the massage device may include a greatly decreased volume that is good for transportation and storing purposes.

It is to be noted that the upwardly extended and rounded projections 12 on the upwardly curved bulge 11 may be used for effectively engaging with the feet of the users and may thus be used for effectively massaging the feet of the users. The base 10 includes a circular peripheral portion having a size for allowing the users to step on the base 10 and to conduct both exercise and massage purposes. The users may hold the handle 30 to support the upper portion of the users and to adjust the reactive force of the massage projections 12 against the feet of the users.

Accordingly, the massage device in accordance with the present invention includes an upwardly curved upper surface having a number of massage projections extended upward therefrom for massaging purposes, and includes a handle provided above the base for supporting the upper portion of the users.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A massage device for massaging feet of user, said massage device comprising:
a base including an upwardly curved upper surface having a plurality of massage projections extended upward therefrom for engaging with and for massaging the feet of the user.

2. The massage device according to claim i further comprising a handle supported above said base for supporting an upper portion of the user.

3. A massage device for massaging feet of user, said massage device comprising:
a base including an upper surface having a plurality of massage projections extended upward therefrom for engaging with and for massaging the feet of the user, and
a handle supported above said base for supporting an upper portion of the user.

4. The massage device according to claim 3, wherein said upper surface of said base is upwardly curved from said base and having said massage projections extended upward therefrom.

5. The massage device according to claim 3, wherein said base includes a circular cross section.

6. The massage device according to claim 3 further comprising means for supporting said handle above said base.

7. The massage device according to claim 6, wherein said supporting means includes at least one tube secured on said base, a rod slidably engaged in said tube, and means for adjustably securing said rod to said tube.

8. The massage device according to claim 7, wherein said base includes at least one recess formed therein for receiving said at least one tube and said rod.

9. The massage device according to claim 7, wherein said base includes at least one recess formed therein for receiving said handle.

10. The massage device according to claim 3, wherein said handle includes a depression formed therein, said massage device further includes a timing device received in said depression of said handle.
